(19) United States
(12) Patent Application Publication
(10) Pub. No.: US 2015/0172770 A1
(43) Pub. Date: Jun. 18, 2015

(54) DISPLAY APPARATUS AND CONTROL METHOD THEREOF

(71) Applicants: SAMSUNG ELECTRONICS CO., LTD., Suwon-si (KR); TOKYO INSTITUTE OF TECHNOLOGY, Tokyo (JP)

(72) Inventors: In-ji KIM, Uijeongbu-si (KR); Yoshihiro MIYAKE, Tokyo (JP); Jinhwan KWON, Daejeon (KR); Sang-on CHOI, Suwon-si (KR); Sung-wook CHOI, Suwon-si (KR)

(73) Assignees: TOKYO INSTITUTE OF TECHNOLOGY, Tokyo (JP); SAMSUNG ELECTRONICS CO., LTD., Suwon-si (KR)

(21) Appl. No.: 14/556,706

(22) Filed: Dec. 1, 2014

(30) Foreign Application Priority Data
Dec. 13, 2013 (KR) 10-2013-0155743

(51) Int. Cl. H04N 21/475; H04H 60/46; H04H 60/47; H04N 21/258; H04N 21/845; H04N 21/45; H04N 21/422; H04N 21/234; H04N 21/44; H04N 21/442; H04N 21/482

(52) U.S. Cl. CPC H04N 21/4755; H04N 21/44218; H04H 60/46; H04H 60/47; H04N 21/25891; H04N 21/4821; H04N 21/4532; H04N 21/42201; H04N 21/23418; H04N 21/44008; H04N 21/8456

(57) ABSTRACT

A display apparatus and control method thereof are provided. The display apparatus includes: a processor configured to process image data of image contents; a display configured to display the image data processed by the processor as an image; a user interface configured to sense a reaction of a user to the image displayed by the display; and a controller configured to determine a preference of the user for the image contents based on the reaction sensed by the user interface. The controller is configured to determine the preference based on an accumulated value of each reaction among a plurality of kinds of reactions generated while the image is displayed and a weight set up corresponding to the reaction. The weight corresponding to the reaction is set up according to genres of the image contents.

### CROSS-REFERENCE TO RELATED APPLICATION

This application claims priority from Korean Patent Application No. 10-2013-0155743, filed on Dec. 13, 2013 in the Korean Intellectual Property Office, the disclosure of which is incorporated herein by reference.

### BACKGROUND

1. Field

Apparatuses and methods consistent with the exemplary embodiments relate to a display apparatus for processing image data from various sources and displaying the processed image data as an image, and a control method thereof, and more particularly to a display apparatus configured to determine a user's preference with regard to a currently displayed image and provide a user with service related to various contents on which the determined preference is reflected, and a control method thereof.

2. Description of the Related Art

A display apparatus processes an image signal input from external image sources and displays the processed image signal as an image on a display panel of various types such as a liquid crystal display (LCD), etc. The display apparatus provided to general users may be achieved by a television (TV), a monitor, etc. For example, the display apparatus realized as the TV applies various processes such as tuning, decoding, etc. to a broadcasting signal transmitted from a broadcasting station to display an image of a broadcasting channel desired by a user, or processes image data received from a content provider connected locally/via a network to display a content image.

Such a display apparatus is not limited to a function of displaying an image based on the image data received from the exterior, but connects for interactive communication with various external devices and a network server to thereby receive or provide various information and data from and to these devices. Recently, there have been many service providers that construct a server and provide various services to the display apparatus. The display apparatus connects with the server of these service providers, and thus receives various kinds of service such as a searching service or a moving image providing service.

However, a user's preference to contents may be required by each service in accordance with characteristics of the service. For example, in the case of a content recommendation service, the service provider may have to know a user's preference in order to determine what contents a user prefers. In the related art, a user has directly input his/her own preference for contents displayed on the display apparatus. However, the related art method needs a user's direct input separately for each service. Accordingly, such a related art method is not appropriate for accumulating the preferences, and also not suitable for receiving the preferences for various contents.

### SUMMARY

According to an aspect of an exemplary embodiment, there is provided a display apparatus including: a processor configured to process image data of image contents; a display configured to display the image data processed by the processor as an image; a user interface configured to sense a reaction of a user to the image displayed by the display; and a controller configured to determine a preference of the user for the image contents based on the reaction sensed by the user interface, wherein the controller is configured to determine the preference based on an accumulated value of each reaction among a plurality of kinds of reactions generated while the image is displayed and a weight set up corresponding to the reaction, and the weight corresponding to the reaction is set up according to genres of the image contents.

The controller may calculate the preference based on a total sum of values obtained by respectively multiplying the accumulated values of the respective reactions with the weights.

The controller may compare the preference with a threshold, and may determine that a user prefers the image contents if the preference is greater than the threshold and determines that a user does not prefer the image contents if the preference is not greater than the threshold.

The accumulated value of the reaction may include a total number of times of showing the reaction, a frequency of showing the reaction, or a percentage of the reaction.

The user interface may sense a user's nod among the plurality of kinds of reactions, and the controller may set up the weight corresponding to the nod as a value higher than those of the weights corresponding to the other reactions if the genre is at least one of a cultural program, an educational program and a documentary program.

The controller may set up the weight corresponding to the nod as a value lower than those of the weights corresponding to the other reactions if the genre is none of a cultural program, an educational program and a documentary program.

The plurality of kinds of reaction may include at least one of change in a user's facial expression, a user's pulse, and a user's eye movement and a user's voice.

The controller may determine the genre of the image contents based on at least one of meta-information about the image data, information about a content analysis for the image contents, and an electronic program guide (EPG).

The controller may divide one of the image contents into a plurality of scenes or reproduction sections, may set up the weight corresponding to one of the reactions to be different according to the respective reproduction sections, and may determine the preference according to the reproduction sections.

The controller may select only some reactions corresponding to the genre of the image contents among the plurality of kinds of reaction, and may calculate the preference based on the selected reaction.

The user interface may be installed in a remove controller remotely separated from the display apparatus, and the user's reaction sensed by the user interface may be transmitted from the remote controller to the display apparatus.

The remote controller may further include an inertial sensor installed in an earphone or headphone that a user puts on, the earphone or the headphone having installed therein an inertial sensor, and the inertial sensor may sense a user's nod among the reactions.

According to an aspect of another exemplary embodiment, there is provided a control method of a display apparatus, the control method including: displaying image data of image contents as an image; sensing a reaction of a user to the image; and determining a preference of the user for the image contents based on the reaction sensed while displaying the image, wherein the determining the preference includes determining the preference based on an accumulated value of each reaction among a plurality of kinds of reactions generated while displaying the image and a weight set up corresponding to the reaction, and the weight corresponding to the reaction is set up according to genres of the image contents.

The determining the preference based on the accumulated value and the weight may include calculating the preference based on a total sum of values obtained by respectively multiplying the accumulated values of the respective reactions with the weights.

The method may further include comparing the preference with a threshold, and determining that a user prefers the image contents if the preference is greater than the threshold and determining that a user does not prefer the image contents if the preference is not greater than the threshold.

The accumulated value of the reaction may include a total number of times of showing the reaction, a frequency of showing the reaction, or a percentage of the reaction.

The sensing the reaction of the user to the image may include sensing a nod of the user among the plurality of kinds of reactions, wherein the weight corresponding to the nod may be set up as a value higher than those of the weights corresponding to the other reactions if the genre is at least one of a cultural program, an educational program and a documentary program.

The weight corresponding to the nod may be set up as a value lower than those of the weights corresponding to the other reactions if the genre is none of a cultural program, an educational program and a documentary program.

The plurality of kinds of reaction may include at least one of change in a user's facial expression, a user's pulse, and a user's eye movement and a user's voice.

The genre of the image contents may be determined based on at least one of meta-information about the image data, information about a content analysis for the image contents, and an electronic program guide (EPG).

The determining the preference of the user for the image contents may include dividing one of the image contents into a plurality of scenes or reproduction sections, setting up the weight corresponding to one of the reactions to be different according to the respective reproduction sections, and determining the preference according to the reproduction sections.

The determining the preference of the user for the image contents may include selecting only some reactions corresponding to the genre of the image contents among the plurality of kinds of reaction, and determining the preference based on the selected reaction.

### BRIEF DESCRIPTION OF THE DRAWINGS

The above and/or other aspects will become apparent and more readily appreciated from the following description of exemplary embodiments, taken in conjunction with the accompanying drawings, in which:

FIG. 1 shows an example of a display apparatus according to a first exemplary embodiment;

FIG. 2 is a block diagram of the display apparatus of FIG. 1;

FIG. 3 is a block diagram of a user interface in the display apparatus of FIG. 1;

FIG. 4 shows an example showing genres sorted according to categories of the contents;

FIG. 5 is a flowchart showing a control method of the display apparatus of FIG. 1, according to a first exemplary embodiment;

FIG. 6 is a flowchart showing a control method of the display apparatus according to a second exemplary embodiment;

FIG. 7 is a flowchart showing a control method of the display apparatus according to a third exemplary embodiment;

FIG. 8 is a flowchart showing a control method of the display apparatus according to a fourth exemplary embodiment;

FIG. 9 is a perspective view of the display apparatus according to a fifth exemplary embodiment; and

FIG. 10 is a block diagram of the display apparatus of FIG. 9.

### DETAILED DESCRIPTION OF EXEMPLARY EMBODIMENTS

Below, exemplary embodiments will be described in detail with reference to accompanying drawings so as to be easily realized by a person having ordinary knowledge in the art. The exemplary embodiments may be embodied in various forms without being limited to the exemplary embodiments set forth herein. Descriptions of well-known parts are omitted for clarity, but this does not mean that the omitted parts are unnecessary for realization of apparatuses or systems to which the exemplary embodiments are applied. Like reference numerals refer to like elements throughout.

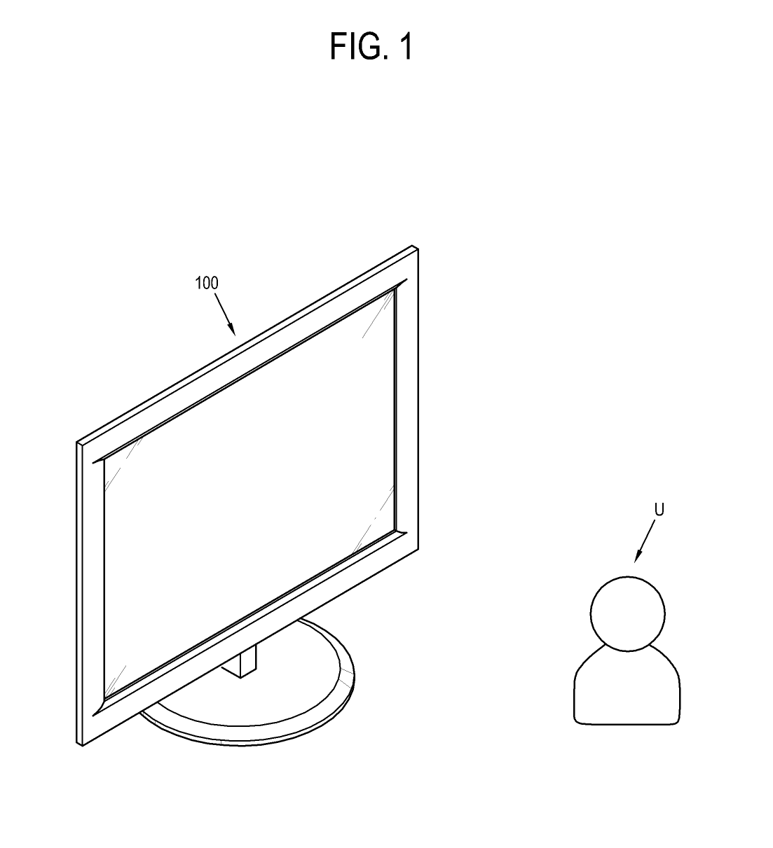

FIG. 1 shows an example of a display apparatus according to a first exemplary embodiment;

As shown in FIG. 1, the display apparatus 100 processes image data of contents received from the exterior or stored therein and displays an image corresponding to the contents. In this exemplary embodiment, the display apparatus 100 is achieved by a TV, but it is not limited thereto. Alternatively, the display apparatus may be achieved by various types of devices capable of processing the image data and displaying an image based on the processed image data.

A user U may be present in front of the display apparatus 100, and may watch an image displayed on the display apparatus 100. The display apparatus 100 may be configured to sense a user's motion, and to analyze a sensing result, thereby determining what motion the user U has.

Below, detailed configurations of the display apparatus 100 will be described.

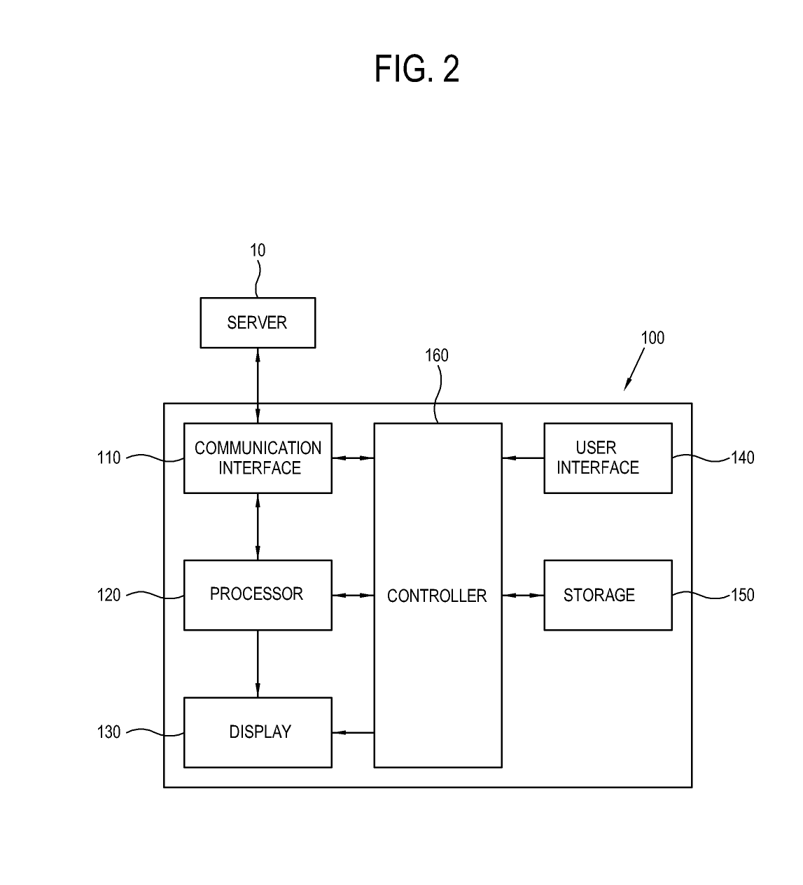

FIG. 2 is a block diagram of the display apparatus according to an exemplary embodiment.

As shown in FIG. 2, the display apparatus 100 in this exemplary embodiment includes a communication interface 110 which performs communication with an exterior to transmit/receive data/a signal, a processor 120 which processes data received in the communication interface 110 in accordance with preset processes, a display 130 which displays image data as an image if data processed in the processor 120 is the image data, a user interface 140 which is for a user's input, a storage 150 which stores data/information, and a controller 160 which controls general operations of the display apparatus 100.

The communication interface 110 transmits/receives data so that interactive communication can be performed between the display apparatus 100 and the server 10 or other external device (not shown). The communication interface 110 accesses the server 10 through wide/local area networks or locally in accordance with preset communication protocols.

The communication interface 110 may be achieved by connection ports according to devices or an assembly of connection modules, in which the protocol for connection or the server 20 or external device (not shown) for connection is not limited to one kind or type. The communication interface 110 may be a built-in device of the display apparatus 100, or the entire or a part thereof may be added to the display apparatus 100 in the form of an add-on or dongle.

The communication interface 110 transmits/receives a signal in accordance with protocols designated according to the connected devices, in which the signals can be transmitted/received based on individual connection protocols with regard to the connected devices. In the case of image data, the communication interface 110 may transmit/receive the signal bases on various standards such as a radio frequency (RF) signal, composite/component video, super video, Syndicat des Constructeurs des Appareils Radiorécepteurs et Téléviseurs (SCART), high definition multimedia interface (HDMI), display port, unified display interface (UDI), or wireless HD, etc.

The processor 120 performs various processes with regard to data/a signal received in the communication interface 110. The processor 120 may be, for example, a central processing unit (CPU) and may be implemented as a microprocessor or microcontroller. If the communication interface 110 receives the image data, the processor 120 applies an imaging process to the image data and the image data processed by this process is output the display 130, thereby allowing the display 130 to display an image based on the corresponding image data. If the signal received in the communication interface 110 is a broadcasting signal, the processor 120 extracts video, audio and appended data from the broadcasting signal tuned to a certain channel, and adjusts a image to have a preset resolution, so that the image can be displayed on the display 130.

There is no limit to the kind of imaging processes to be performed by the processor 120. For example, the processes may include decoding corresponding to an image format of the image data, de-interlacing for converting the image data from an interlace type into a progressive type, scaling for adjusting the image data to have a preset resolution, noise reduction for improving image qualities, detail enhancement, frame refresh rate conversion, etc.

The processor 120 may perform various processes in accordance with the kinds and attributes of data, and thus the process to be implemented in the processor 120 is not limited to the imaging processes. Also, the data processable in the processor 120 is not limited to only that received in the communication interface 110. For example, the processor 120 may process a user's utterance through a preset voicing process when the user interface 140 receives the corresponding utterance, and process a sensing result through a preset gesture process when the user interface 140 senses a user's gesture.

The processor 120 may be achieved by an image processing board (not shown) that a system-on-chip where various functions are integrated or an individual chip-set capable of independently performing each process is mounted on a printed circuit board. The processor 120 may be built-in in the display apparatus 100.

The display 130 displays the video signal/the image data processed by the processor 120 as an image. The display 130 may be achieved by various display types such as liquid crystal, plasma, a light-emitting diode, an organic light-diode, a surface-conduction electron-emitter, a carbon nano-tube and a nano-crystal, but not limited thereto.

The display 130 may additionally include an appended element in accordance with the type of the display. For example, in the case of the liquid crystal type display, the display 130 may include a liquid crystal display (LCD) panel (not shown), a backlight (not shown) which emits light to the LCD panel, a panel driving substrate (not shown) which drives the panel (not shown), etc.

The user interface 140 transmits various preset control commands or information to the controller 160 in accordance with a user's control or input. The user interface 140 informationizes various events that occur in accordance with a user's intentions and transmits informationized event to the controller 160. Here, the events that occur by a user may have various forms, and may for example include a user's control, utterance, gesture, etc.

The storage 150 stores various data under control of the controller 160. The storage 150 is achieved by a nonvolatile memory such as a flash memory, a hard disk drive, etc. so as to retain data regardless of power on/off of the system. The storage 150 is accessed by the controller 160 so that previously stored data can be read, recorded, modified, deleted, updated, and so on.

The controller 160 is achieved by a central processing unit (CPU), and controls operations of general elements of the display apparatus 100, such as the processor 120, in response to occurrence of a predetermined event. For example, if the communication interface 110 receives the image data of predetermined contents, the controller 160 controls the processor 120 to process the image data to be displayed as an image on the display 130. Also, the controller 160 controls the elements such as the processor 120 to implement a preset operation corresponding to a user's input event when the corresponding event occurs through the user interface 140.

Below, detailed configurations of the user interface 140 will be described.

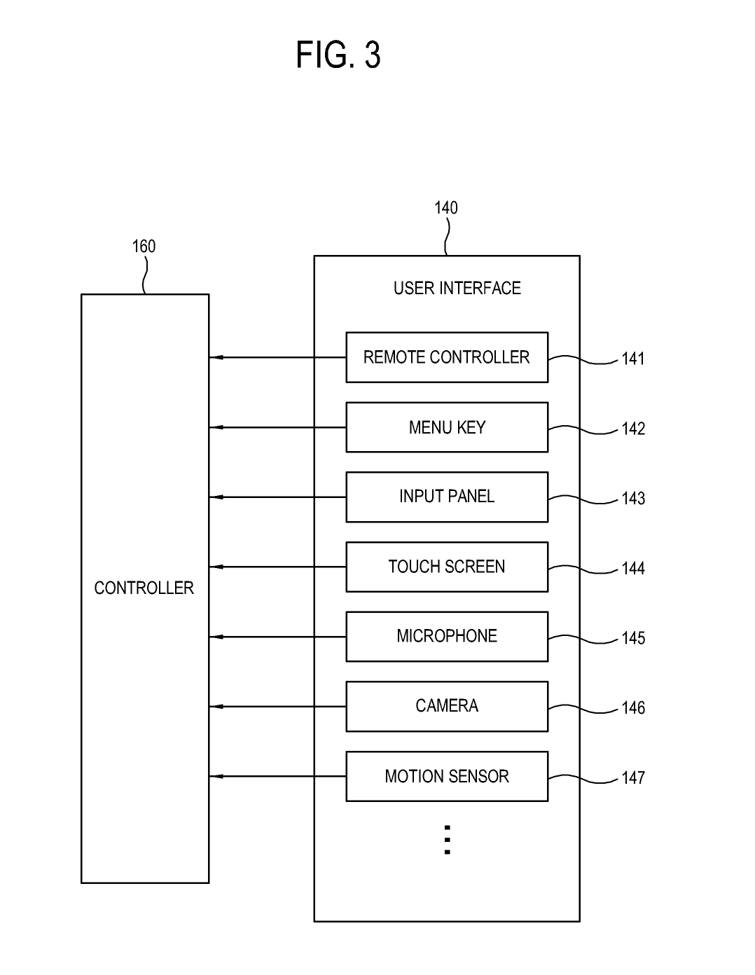

FIG. 3 is a block diagram of the user interface in the display apparatus of FIG. 1.

As shown in FIG. 3, the user interface 140 refers to environments of the display apparatus 100, through which a user's intention is transferred to the controller 160 so that the controller 160 can perform operations corresponding to the user's intention. Thus, in response to a user's manner of inputting information, the user interface 140 is provided to sense information input in the corresponding manner by him/her. That is, the user interface 140 is achieved by a group of interfaces corresponding to various input manners of a user.

For example, the user interface 140 may include a remote controller 141 separated from the display apparatus 100, a menu key 142 or input panel 143 provided outside the display apparatus 100, a touch screen 144 provided on the display 130, a microphone 145 to which a user's utterance is input, a camera 146, or a motion sensor 147 for sensing a user's motion, etc. The remote controller 141 may be in the form of an earphone or headphone that is worn by the user. The earphone or headphone may include an inertia sensor that senses a user's motion, as will be described in more detail later.

Such elements of the user interface 140 are respectively connected to the controller 160, and transmit an input event or a sensed event generated by a user to the controller 160.

However, the user interface 140 does not have to include all the foregoing elements, and may exclude some elements or include new elements in accordance with different types of the display apparatus 100.

The camera 146 may be installed at the outside of the display apparatus 100. The camera 146 takes an image or a moving image of external environments of the display apparatus 100. In this exemplary embodiment, the camera 146 photographs or senses a user who watches the image displayed on the display apparatus 100, and transmits a photographing or sensing result from change in a user's motion to the controller 160. Thus, the controller 160 controls the processor 120 to analyze the sensing results, and determines the change in a user's motion sensed by the camera 146 in accordance with time.

In particular, the controller 160 can sense the change in a user's unconscious motion with respect to a user's face through the user interface 140. For example, in order to sense a user's unconscious motion, the controller 160 may determine change in a user's facial expression, a user's nod, a user's pulse, and a user's eye movement in accordance with the results sensed by the camera 146 and/or the motion sensor 147. Also, the controller 160 may sense a user's voice through the microphone 145.

With this configuration, the display apparatus 100 can display images of contents provided from various sources.

The contents to be displayed as the images by the display apparatus 100 may correspond to one of various genres. Various genres of the contents may for example include a sport, a drama, a movie, an animation, a comedy, an education, a documentary, etc.

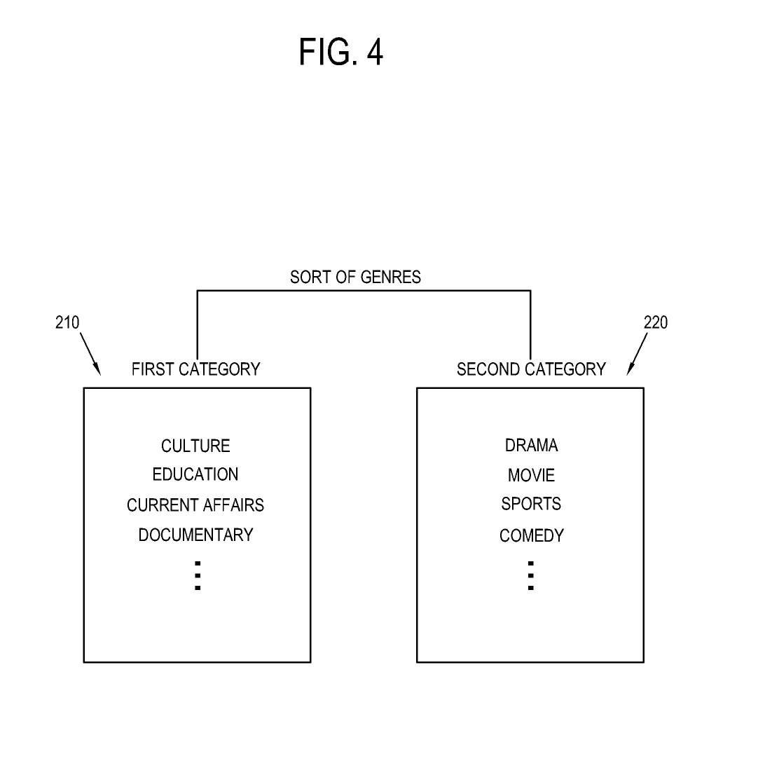

Also, there are many methods of sorting such various genres according to categories. For example, each genre may be classified one of two categories corresponding to the contents as explained below with reference to FIG. 4.

FIG. 4 shows an example showing genres sorted according to categories of the contents.

As shown in FIG. 4, various genres may be sorted into a first category 210 related to static contents and a second category 220 related to dynamic contents in accordance with the contents. Here, the terms of ‘static’ and ‘dynamic’ are defined for convenience of relative comparison, and do not limit the scope of the invention.

The first category 210 includes the genre of the contents intended for giving knowledge to a user. For example, the first category 210 may include the genre of a cultural program, an educational program, a program for current-affairs, a documentary, etc.

The second category 220 includes the genre of the contents intended for giving entertainment rather than knowledge to a user. For example, the second category 220 may include the genre of a drama, a movie, a sport, a comedy, etc.

The foregoing sorting into the first category 210 and the second category 220 is nothing but an example introduced for convenience to clearly explain the exemplary embodiment. Alternatively, the number of categories, the kind of categories, sorting methods, a sorting reference, etc. may vary depending on schemes without limitation.

While a user watches contents corresponding to a predetermined genre, the user tends to show a certain reaction to the corresponding contents in accordance with what contents the corresponding genre has, i.e., what category 210, 220 the corresponding genre is sorted into. This is because a user expresses his/her feelings differently according to the contents and thus his/her reaction also varies.

For example, if there are a user's reactions such as change in his/her facial expression, his/her nod, his/her pulse, his/her eye movement, his/her voice, etc., s/the user may show the nod more frequently than the other reactions with respect to the contents of the genre of the first category 210. This is because the first category 210 is to give knowledge to a user and evoke his/her understanding. One remarkable form in which humans show understanding of knowledge is by nodding as if to say “ah, I understand.”. In this case, among the user's reactions with respect to the contents of the genres of the first category 210, the reactions other than the nod are not remarkably shown.

On the contrary to the first category 210, a user does not remarkably nod his/her head with respect to the contents of the genre of the second category 220. Instead, a user may show the reactions such as his/her pulses, voice, etc. more frequently than the nod.

In this exemplary embodiment, only the first category 210 and the second category 220 are described, but the categories are not limited thereto. Alternatively, if the number of categories increases, the remarkable reactions are increased according to the categories. Also, the categories are different in the frequency of the remarkable reaction, and therefore importance of each reaction corresponding to the category is differentially applied.

The following is deduced from the foregoing descriptions. A user's preference to a predetermined content is determined or selected according to his/her reaction with respect to the corresponding contents. Here, the remarkable reaction is varied depending on the genre of the contents. Therefore, if only the number of times of showing a certain reaction is taken into account without considering the kind of reaction, the preference is not accurately determined. To more accurately determine a user's preference, it is advantageous to consider not only the number of times of showing the reaction but also the importance for the kind of reaction with respect to the genre of the contents.

In the example discussed above, the reaction corresponding to the nod is remarkably shown with respect to the first category 210, but not remarkably shown with respect to the second category 220. This means that it is difficult to deduce a user's preference from the reaction of nodding his/her head in the case of the second category 220, in other words it is difficult to deduce the user's preference from the reactions other than the nod related to sympathy in the case of the first category 210.

Thus, the display apparatus 100 according to an exemplary embodiment employs the following method to determine a user's preference with respect to image contents.

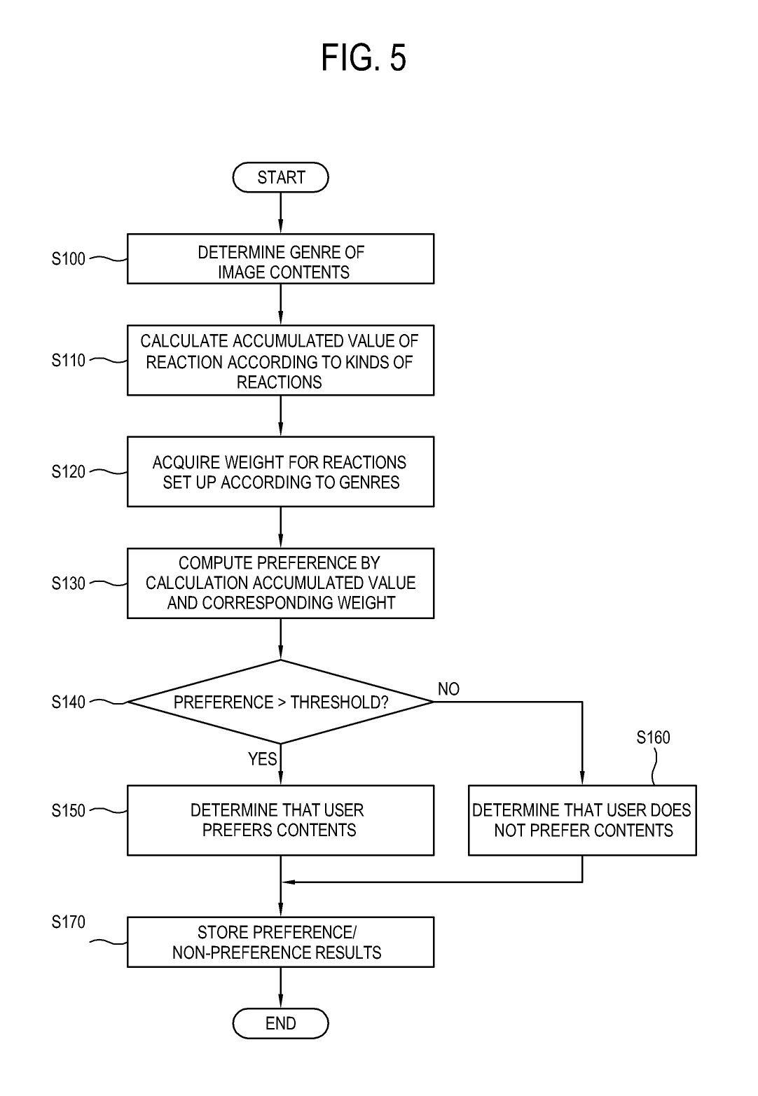

FIG. 5 is a flowchart showing a control method of the display apparatus according to a first exemplary embodiment.

As shown in FIG. 5, at operation S100 the display apparatus 100 determines the genre of image contents.

The display apparatus 100 has various methods for determining the genre of the image contents. For example, the display apparatus 100 may determine the genre based on meta-information of the image data, a variety of analysis for the image data, or an electronic program guide (EPG).

At operation S110, the display apparatus 100 senses a plurality of preset kinds of reaction and calculates an accumulated value of the number of reaction times according to the kinds of reaction while displaying the image contents.

The kinds of reaction may include a change in a user's facial expression, a user's nod, a user's pulse, a user's eye movement, a user's voice, etc. as described above. The accumulated value of the number of reaction times according to the kinds of reaction refers to a value obtained by quantifying how remarkably the corresponding reaction is made while the image contents are displayed.

Here, the accumulated value may be expressed by a total number of times of or a frequency of showing a certain reaction, by a numerical level of the reaction, or by a percentage of the reaction.

However, the foregoing expression is just a method of digitizing the accumulated value of the reaction, and the accumulated value may be achieved by various methods. The nod, voice, etc. among the reactions are easy to sense the number of reaction times, whereas the pulses, eye movements, etc. are not as easy to sense the number of reaction times. Accordingly, the accumulated value may be calculated by various models in accordance with the kinds of reaction.

For example, in the case of the user's nod, the accumulated value of the corresponding reaction may be expressed by the number of times that the user nods his/her head. In the case of the user's eye movements, the accumulated value of the corresponding reaction may be expressed by the number of times that the user blinks his/her eyes. In the case of the user's pulses, the accumulated value of the corresponding reaction may be expressed by a percentage of the number of his/her pulses equal to or higher than a threshold value with regard to a total reproduction time of the image contents. The threshold value may be predetermined.

At operation S120, the display apparatus 100 acquires a weight of each reaction set up according to the genre of the image contents. The weight is a value provided corresponding to the kind of reaction, and is varied depending on the genres.

If the genre belongs to the first category 210 (refer to FIG. 3), the weight of the nod is set up to have a relatively high value, and the weights of the other reactions are set up to have a relatively low value. On the other hand, if the genre belongs to the second category 220 (refer to FIG. 3), the weight of the nod is set up to have a relatively low value, and the weights of the other reactions are set up to have a relatively high value. Here, a real value of each weight is not limited to a specific value since various values may be applied. However, according to an exemplary embodiment, it is advantageous that the weight to the reaction is not invariable, but varied depending on the genre of the image contents.

At operation S130, the display apparatus 100 calculates the accumulated value of each reaction and the corresponding weight, and computes the preference.

For example, if an accumulated value about change in a user's facial expression is P1, an accumulated value about a user's operation of nodding his/her head is P2, an accumulated value about a user's pulse is P3, an accumulated value about a user's eye movements is P4, and an accumulated value about a user's voice is P5, and if the weights corresponding to the accumulated values of the respective reactions are C1, C2, C3, C4 and C5, a final value, i.e., a user's preference F is calculated by the following expression.

F=C1*P1+C2*P2+C3*P3+C4*P4+C5*P5

That is, the preference can be represented in a total sum of values obtained by multiplying the accumulated values with the weights of the respective reactions.

At operation S140, the display apparatus 100 determines whether a user's preference F is greater than a threshold T, i.e., F>T. The threshold T may be preset and may be variously determined in the procedure of designing the display apparatus 100, and is not limited to a specific value.

If it is determined that F is greater than T, at operation S150 the display apparatus 100 determines that a user's preference to the corresponding image contents is high or that a user prefers the corresponding image contents. On the other hand, if it is determined that F is not greater than T, at operation S160 the display apparatus 100 determines a user's preference to the corresponding image contents is low or that a user does not prefer the corresponding image contents.

At operation S170, the display apparatus 100 stores the foregoing calculated preference or results from preference/non-preference to the image contents. A history database of the preference stored in the display apparatus 100 with respect to various image contents may be utilized for various services such as content recommendation for a user.

As described above, the display apparatus 100 determines a user's preference with respect to the image contents based on a user's reaction to an image while the image of the image contents is displayed. The display apparatus 100 calculates the preference based on the operation between the accumulated values of the respective reactions according to the plurality of types or kinds of reaction performed while displaying the image and the weights set up corresponding to these reactions.

Here, the weight corresponding to one of the reactions is not invariable, and set up differently corresponding to the genre of the image contents.

Although users are different in the kind of reaction according to the genre of the image contents, the display apparatus 100 considers the kind of user's reaction according to the genres when determining a user's preference and thus more accurately determines the user's preference.

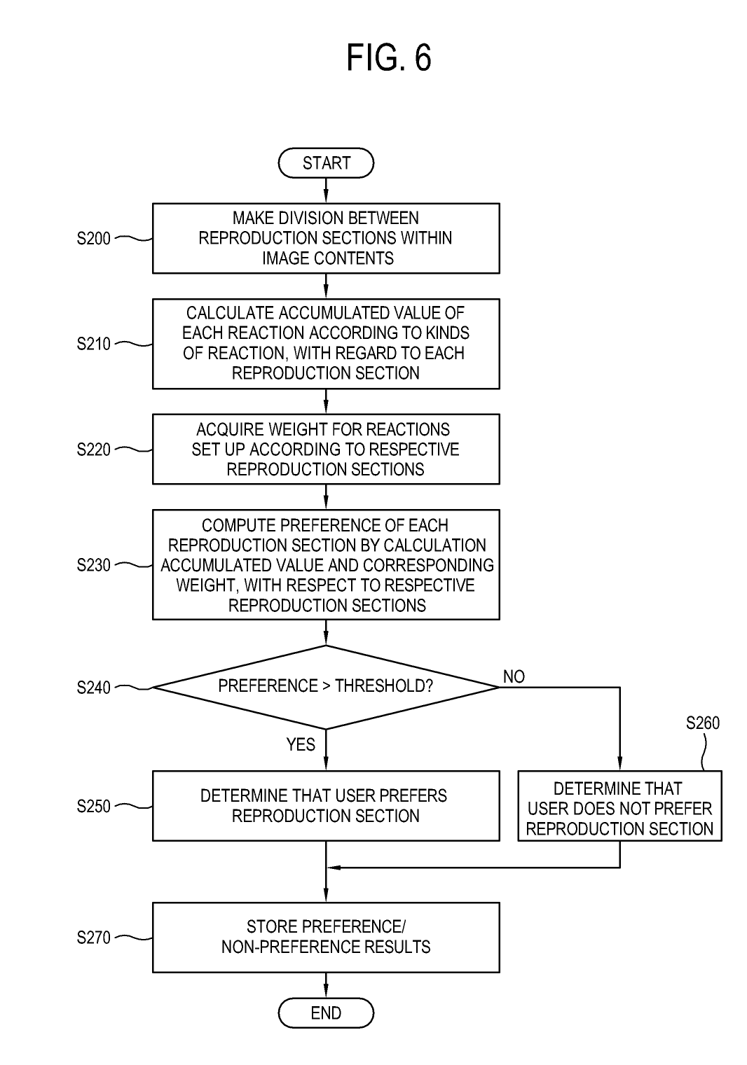

FIG. 6 is a flowchart showing a control method of the display apparatus according to a second exemplary embodiment.

In the foregoing first exemplary embodiment, the method of determining a user's preference is performed with respect to the whole image contents. However, the image contents may be divided into a plurality of reproduction sections according to contents, and a user's preference may be determined with respect to each reproduction section. This will be described below.

As shown in FIG. 6, at operation S200 the display apparatus 100 makes a division into the reproduction sections of the image contents. The method of making a division into the reproduction sections may be variously achieved with respect to the references such as subtitle contents in the reproduction section, an image analysis, etc.

For example, the image contents may be divided into a plurality of sections according to contents of a scene. If the image contents show a soccer game, the corresponding image contents may be divided into a first section corresponding to a game scene, a second section corresponding to a scoring play scene, a third section corresponding to a commentary scene, and a fourth section corresponding to a resumed game scene. Likewise, if the image contents show a movie, the corresponding image contents may be divided into a first section corresponding to a prologue scene, a second section corresponding to a plot development scene, and a third section corresponding to a climax and ending scene. Of course, such methods of making the division are just some cases of the simplest examples, and the reproduction sections may be divided within the image contents by more detailed and complicated methods.

At operation S210, the display apparatus 100 calculates the accumulated value of reactions according to the kinds of reaction, with respect to each reproduction section while reproducing the image contents. The first exemplary embodiment is applicable to the kinds of reaction and the description about the accumulated value according to this exemplary embodiment, and thus detailed descriptions thereof will be omitted.

At operation S220, the display apparatus 100 acquires a weight of each reaction set up according to the reproduction sections. In the first exemplary embodiment, the weight corresponding to one of the reactions is determined according to the genres of the image contents. On the other hand, in this exemplary embodiment, the weight corresponding to one of the reactions is determined according to the scenes of the image contents or the reproduction sections.

For example, if the second section corresponding to the scoring play scene and the third section corresponding to the commentary scene are compared within the image contents showing a soccer game, a user's reaction such as pulses, eye movements or the like is relatively remarkably shown in the second section, but his/her reaction such as a nod is relatively remarkably shown in the third section. Therefore, the display apparatus 100 sets up the weight corresponding to one reaction differently according to the reproduction sections with respect to the same image contents.

At operation S230, the display apparatus 100 calculates the accumulated value of each reaction with regard to the reproduction section and the corresponding weight, and computes the preference according to the reproduction sections.

For example, if a user's preference is F1 in the first reproduction section, F1 is represented in a total sum of values obtained by multiplying the accumulated values with the weights of the respective reactions in the first reproduction section. Here, the first exemplary embodiment may be applied to this example.

However, the weight corresponding to the accumulated value of the reaction may be represented as different values according to the reproduction sections within one image content. For example, the weight corresponding to the nod is set up as a relatively high value in the third section corresponding to the commentary scene of the soccer game, but as a relatively low value in the other reproduction sections.

At operation S240, the display apparatus 100 determines whether the preference of each reproduction section is greater than a threshold. The threshold may be preset. In this exemplary embodiment, the threshold may also be determined as various values in the procedure of designing the display apparatus 100, and is not limited to a specific value.

For example, if it is determined that the preference in a certain reproduction section is greater than the threshold, at operation S250 the display apparatus 100 determines that a user's preference to the corresponding image contents is high or that a user prefers the corresponding image contents. On the other hand, if it is determined that the preference in a certain reproduction section is not greater than the threshold, at operation S260 the display apparatus 100 determines a user's preference to the corresponding image contents is low or that a user does not prefer the corresponding image contents.

At operation S270, the display apparatus 100 stores the foregoing calculated preference or results from preference/non-preference to the reproduction sections. For example, the display apparatus 100 may put a tag on the preferred reproduction section determined as a preferred section one, so that a user can easily reproduce the corresponding reproduction section of the image contents.

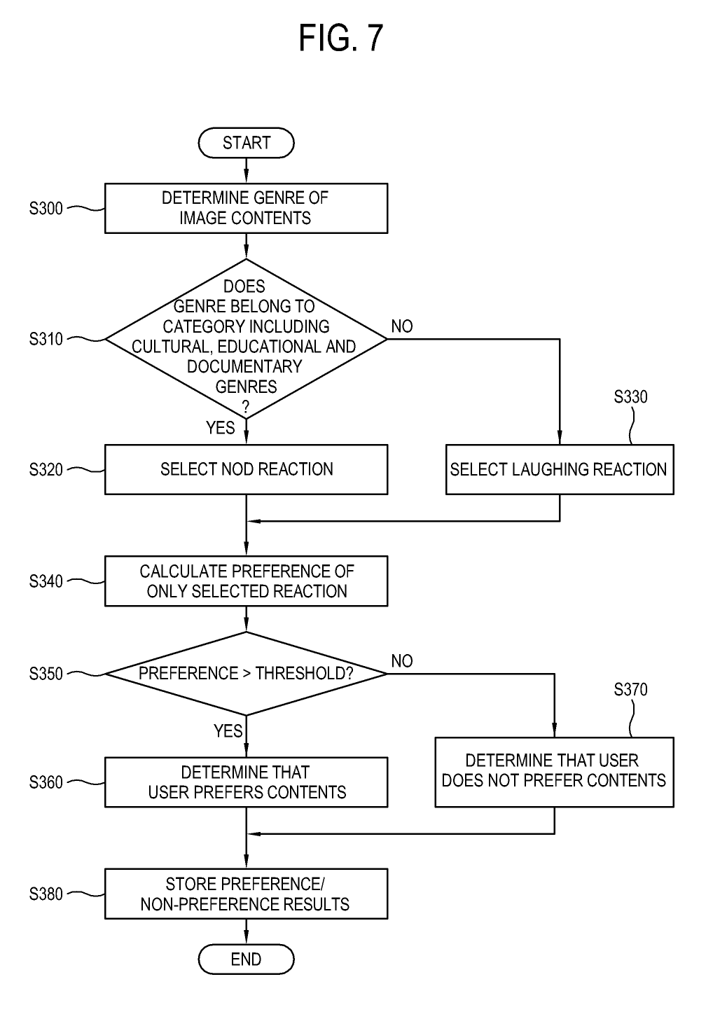

FIG. 7 is a flowchart showing a control method of the display apparatus according to a third exemplary embodiment.

In the foregoing exemplary embodiments, the weight corresponding to a user's one reaction is set up differently according to the genres or reproduction sections while determining a user's preference to one image content or to each of the plurality of reproduction sections within one image content. However, such an exemplary embodiment may be achieved in another form. For example, one among a plurality of reactions determinable according to the genres or the plurality of reactions may be selected instead of adjusting the weight while determining a user's preference to one image content. This will be described below with reference to FIG. 7.

As shown in FIG. 7, at operation S300, the display apparatus 100 determines the genre of the image contents. The first exemplary embodiment may be applicable to the detailed method of determining the genre of the image contents.

At operation S310, the display apparatus 100 determines whether the determined genre belongs to category including cultural, educational and documentary genres.

If the genre of the image contents belongs to the category including the cultural, educational and documentary genres, at operation S320 the display apparatus 100 selects a nod among the plurality of reactions.

On the other hand, if the genre of the image contents does not belong to the category including the cultural, educational and documentary genres, at operation S330 the display apparatus 100 selects a reaction excluding the nod. For example, the display apparatus 100 may select a laughing reaction among the plurality of reactions.

At operation S340, the display apparatus 100 calculates the preference of only the reaction selected at the operation S320 or S330. Here, only one reaction is sensed while reproducing the image contents, and therefore the accumulated value of the reaction is taken into account, but there is no need to consider the weight in contrary to the foregoing exemplary embodiments.

However, as an alternative, a plurality of reactions may be selected at the operation S320 or S330. In this case, the plurality of reactions is taken into account while calculating the preference, and therefore the weight may be additionally applied like the foregoing exemplary embodiments.

At operation S350, the display apparatus 100 determines whether the calculated preference is greater than the threshold. The threshold may be preset. The threshold may also be determined as various values in the procedure of designing the display apparatus 100, and is not limited to a specific value.

For example, if it is determined that the preference is greater than the threshold, at operation S360 the display apparatus 100 determines that a user's preference to the corresponding image contents is high or that a user prefers the corresponding image contents. On the other hand, if it is determined that the preference is not greater than the threshold, at operation S370 the display apparatus 100 determines a user's preference to the corresponding image contents is low or that a user does not prefer the corresponding image contents.

At operation S380, the display apparatus 100 stores the foregoing calculated preference or results from preference/non-preference to the image contents.

That is, in this exemplary embodiment, the display apparatus 100 selects only some kinds of reaction among the plurality of kinds of reaction corresponding to the genre of the image contents, and calculates the preference based on the selected reactions.

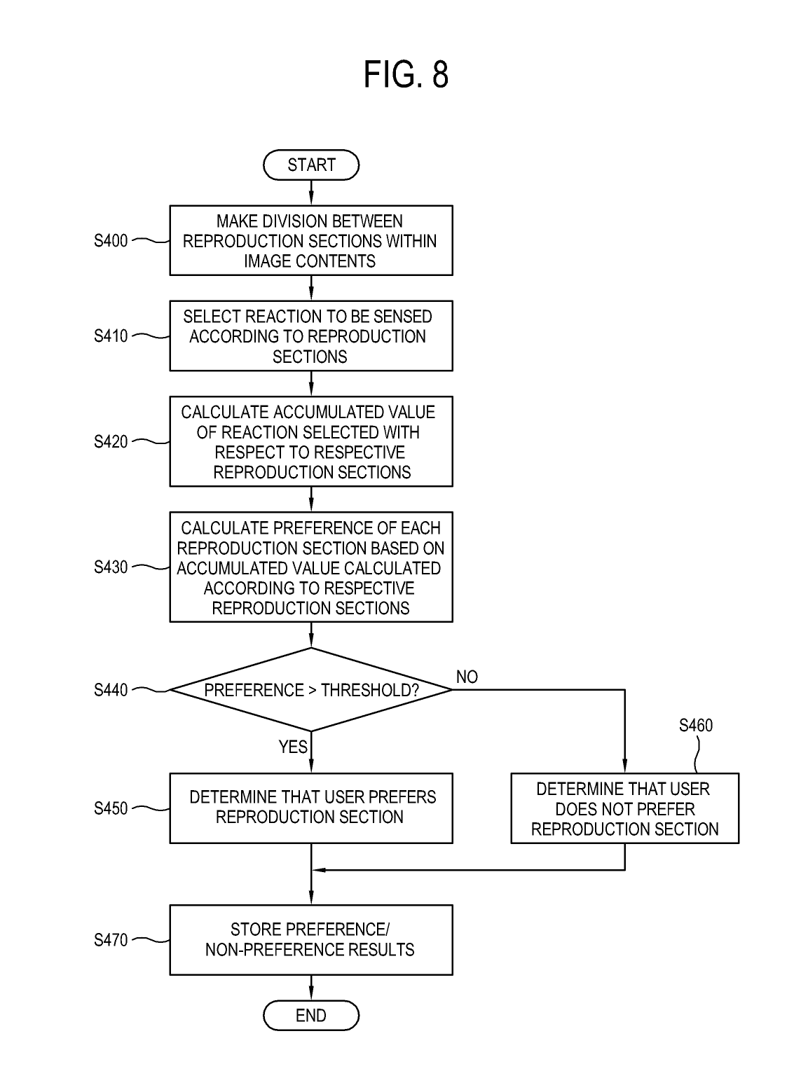

FIG. 8 is a flowchart showing a control method of the display apparatus according to a fourth exemplary embodiment.

In the third exemplary embodiment, the reaction for calculating the preference is selected according to the genres of the image contents, but the method of selection is not limited thereto. Alternatively, the reaction may be individually selected with respect to each of the plurality of reproduction sections divided within one image content prior to calculating the preference, which will be described below. Here, the foregoing exemplary embodiments may be applicable to the description about the reproduction sections of the image contents.

As shown in FIG. 8, at operation S400 the display apparatus 100 makes a division among the reproduction sections within one image content.

At operation S410, the display apparatus 100 selects a reaction to be sensed corresponding to each reproduction section. Here, a method of selecting the reaction corresponding to the reproduction section may be similar to the method of setting up the weight in the foregoing second exemplary embodiment. For example, the display apparatus 100 may select the reaction, which is remarkably frequently shown in a certain reproduction section, in accordance with the corresponding reproduction section.

At operation S420, the display apparatus 100 calculates the accumulated value of the reaction selected with regard to each of the reproduction sections while reproducing the image contents.

At operation S430, the display apparatus 100 calculates the preference of each reproduction section based on the accumulated values calculated according to the respective reproduction sections. Here, the preference may be calculated by only the accumulated value without considering the weight if one reaction is taken into account, or by applying each weight to the accumulated value of each reaction if two or more reactions are taken into account. However, the calculation of the preference may be achieved by various methods, and is not limited to the above-described exemplary embodiments.

At operation S440, the display apparatus 100 determines whether the preference of each reproduction section is greater than the preset threshold. In this exemplary embodiment, the threshold may be variously determined in the procedure of designing the display apparatus 100, and is not limited to a specific value.

For example, if it is determined that the preference of a certain reproduction section is greater than the threshold, at operation S450 the display apparatus 100 determines a user's preference to the corresponding reproduction section is high or that a user prefers the corresponding reproduction section. On the other hand, if it is determined that the preference of a certain reproduction section is not greater than the threshold, at operation S460 the display apparatus 100 determines a user's preference to the corresponding reproduction section is low or that a user does not prefer the corresponding reproduction section.

At operation S470, the display apparatus 100 stores the foregoing calculated preference or results from preference/non-preference to the reproduction section.

The display apparatus 100 of the foregoing exemplary embodiments is the TV, but the display apparatus not limited thereto. Alternatively, the present exemplary embodiments may be applied to various display apparatuses.

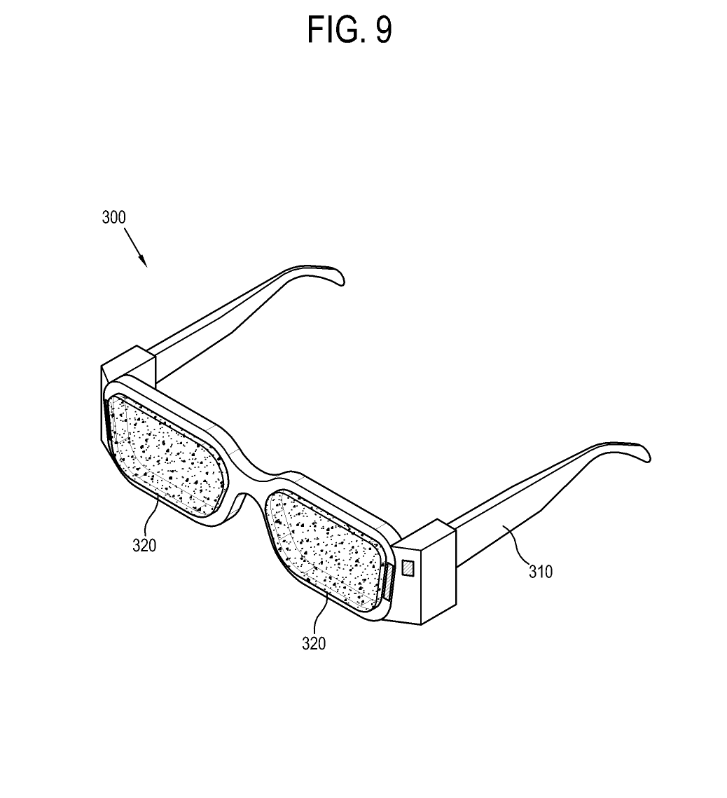

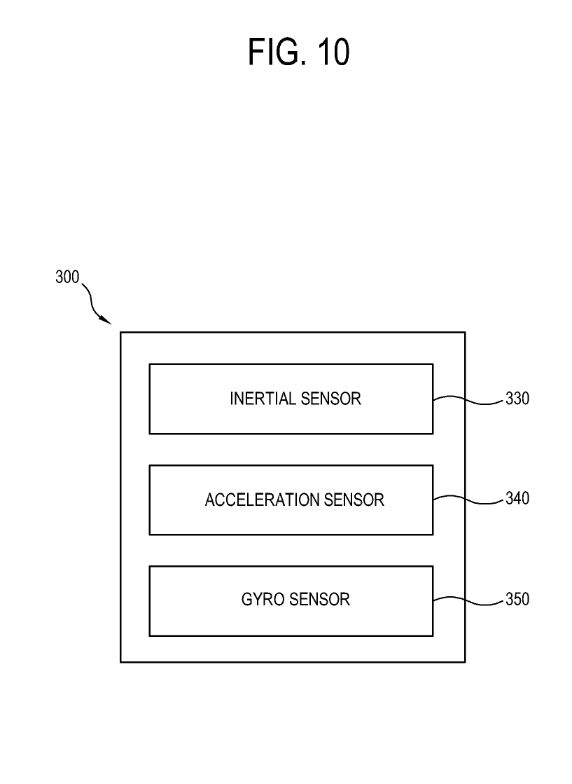

FIG. 9 is a perspective view of a display apparatus according to another exemplary embodiment, and FIG. 10 is a block diagram of the display apparatus of FIG. 9.

As shown in FIG. 9, the display apparatus 300 according to an another exemplary embodiment is a head-mount type display apparatus that can be mounted to a user's head. This display apparatus 300 is shaped like general glasses, and includes a frame 310 put on a user's head or ears, and glass units 320 supported by the frame 310 and covering a user's left and right eye views.

The frame 310 and the glass unit 320 may have an inner space to accommodate various elements for operating the display apparatus 300, without limitation to their shapes and materials.

The display apparatus 300 may perform the same operation as those of the foregoing exemplary embodiments. However, contrary to that of the first exemplary embodiment, the display apparatus 300 of this exemplary embodiment is put on a user's head, and may thus have a different structure for sensing his/her reaction.

For example, as shown in FIG. 10, the display apparatus 300 may include an inertial sensor 330, an acceleration sensor 340, a gyro sensor 350, etc. If a user nods his/her head, the display apparatus 300 is also shaken up and down. The inertial sensor senses such a motion of the display apparatus 300 and thus determines that a user nods his/her head.

Alternatively, such a sensor may be installed in not the display apparatus 300 but a separate external device capable of communicating with the display apparatus 300. For example, a sensor structure may be installed in an earphone or headphone (not shown) that a user puts on, thereby sensing his/her nod.

However, various methods and structures for sensing a user's reaction may be applied to the display apparatus 300 according to the types of the display apparatus 300, and the methods and structures are not limited to the foregoing description.

Although a few exemplary embodiments have been shown and described, it will be appreciated by those skilled in the art that changes may be made in these exemplary embodiments without departing from the principles and spirit of the inventive concept, the scope of which is defined in the appended claims and their equivalents.

What is claimed is:

1. A display apparatus comprising:
a processor configured to process image data of image contents;
a display configured to display the image data processed by the processor as an image;
a user interface configured to sense a reaction of a user to the image displayed by the display; and
a controller configured to determine a preference of the user for the image contents based on the reaction sensed by the user interface,
wherein the controller is configured to determine the preference based on an accumulated value of each reaction among a plurality of kinds of reactions generated while the image is displayed and a weight set up corresponding to the reaction, and
wherein the weight corresponding to the reaction is set up according to genres of the image contents.

2. The apparatus according to claim 1, wherein the controller is configured to determine the preference based on a total sum of values obtained by respectively multiplying the accumulated values of the respective reactions with the weights.

3. The apparatus according to claim 1, wherein the controller is configured to compare the preference with a threshold, and determine that the user prefers the image contents if the preference is greater than the threshold and determine that the user does not prefer the image contents if the preference is not greater than the threshold.

4. The apparatus according to claim 1, wherein the accumulated value of the reaction comprises a total number of times of showing the reaction, a frequency of showing the reaction, or a percentage of the reaction.

5. The apparatus according to claim 1, wherein the user interface is configured to sense a nod of the user among the plurality of kinds of reactions, and
the controller is configured to set the weight corresponding to the nod as a value higher than those of the weights corresponding to other reactions if the genre is at least one of a cultural program, an educational program and a documentary program.

6. The apparatus according to claim 5, wherein the controller is configured to set the weight corresponding to the nod as a value lower than those of the weights corresponding to the other reactions if the genre is none of a cultural program, an educational program and a documentary program.

7. The apparatus according to claim 5, wherein the plurality of kinds of reaction comprises at least one of change in a facial expression of the user, a pulse of the user, and an eye movement of the user and a voice of the user.

8. The apparatus according to claim 1, wherein the controller is configured to determine the genre of the image contents based on at least one of meta-information about the image data, information about a content analysis for the image contents, and an electronic program guide.

9. The apparatus according to claim 1, wherein the controller is configured to divide one of the image contents into a plurality of scenes or reproduction sections, sets up the weight corresponding to one of the reactions to be different according to the respective reproduction sections, and determine the preference according to the reproduction sections.

10. The apparatus according to claim 1, wherein the controller is configured to select only some reactions corresponding to the genre of the image contents among the plurality of kinds of reaction, and determines the preference based on the selected reaction.

11. The apparatus according to claim 1, wherein the user interface is installed in a remote controller remotely separated from the display apparatus, and the reaction of the user sensed by the user interface is transmitted from the remote controller to the display apparatus.

12. The apparatus according to claim 11, wherein the remote controller comprises an earphone or headphone, having installed therein an inertial sensor, and
wherein the inertial sensor senses a nod of the user among the reactions.

13. A control method of a display apparatus, the control method comprising:
displaying image data of image contents as an image;
sensing a reaction of a user to the image; and
determining a preference of the user for the image contents based on the reaction sensed while the image is displayed,
wherein the determining the preference of the user comprises determining the preference based on an accumulated value of each reaction among a plurality of kinds of reactions generated while the image is displayed and a weight set up corresponding to the reaction, and
the weight corresponding to the reaction is set up according to genres of the image contents.

14. The control method according to claim 13, wherein the determining the preference based on the accumulated value and the weight comprises determining the preference based on a total sum of values obtained by respectively multiplying the accumulated values of the respective reactions with the weights.

15. The control method according to claim 13, further comprising: comparing the preference with a threshold, and determining that the user prefers the image contents if the preference is greater than the threshold, and determining that the user does not prefer the image contents if the preference is not greater than the threshold.

16. The control method according to claim 13, wherein the accumulated value of the reaction comprises a total number of times of showing the reaction, a frequency of showing the reaction, or a percentage of the reaction.

17. The control method according to claim 13, wherein the sensing the reaction of the user to the image comprises:
sensing a nod of the user among the plurality of kinds of reactions,
wherein the weight corresponding to the nod is set as a value higher than those of the weights corresponding to the other reactions if the genre is at least one of a cultural program, an educational program and a documentary program.

18. The method according to claim 17, wherein the weight corresponding to the nod is set up as a value lower than those of the weights corresponding to the other reactions if the genre is none of a cultural program, an educational program and a documentary program.

19. The method according to claim 17, wherein the plurality of kinds of reaction comprises at least one of change in a facial expression of the user, a pulse of the user, an eye movement of the user and a voice of the user.

20. The method according to claim 13, wherein the genre of the image contents is determined based on at least one of meta-information about the image data, information about a content analysis for the image contents, and an electronic program guide.

21. The method according to claim 13, wherein the determining the preference of the user for the image contents comprises:
dividing one of the image contents into a plurality of scenes or reproduction sections;
setting up the weight corresponding to one of the reactions to be different according to the respective reproduction sections; and
determining the preference according to the reproduction sections.

22. The method according to claim 13, wherein the determining the preference of the user for the image contents comprises selecting only some reactions corresponding to the genre of the image contents among the plurality of kinds of reaction, and determining the preference based on the selected reaction.

23. A display apparatus comprising:
a processor configured to process image data of image contents;
a display configured to display the image data as an image;
a plurality of sensors, each sensor configured to sense a different kind of reaction of a user among a plurality of kinds of reactions, while the image is being displayed by the display; and
a controller configured to automatically determine a preference of a user for the image contents based on results from the plurality of sensors while the image is being displayed by the display.
